(19) United States
(12) Patent Application Publication
(10) Pub. No.: US 2012/0063463 A1
(43) Pub. Date: Mar. 15, 2012

(54) Packet aligning apparatus and packet aligning method

(75) Inventor: Takeo Hayashi, Tokyo (JP)

(73) Assignee: NEC Corporation, Tokyo (JP)

(21) Appl. No.: 13/317,356

(22) Filed: Oct. 17, 2011

Related U.S. Application Data
(63) Continuation of application No. PCT/JP2011/051435, filed on Jan. 26, 2011.

(30) Foreign Application Priority Data
Feb. 22, 2010 (JP) 2010-036002

(51) Int. Cl. H04L 12/56

(52) U.S. Cl. 370/394

(57) ABSTRACT

A packet aligning apparatus includes a packet analyzing section configured to receive a reception packet, and extract a sequence number contained in the reception packet; a packet storage section; a write control section configured to determine whether the reception packet is stored in the packet storage section based on the extraction sequence number or transferred to a subsequent block; an expectation managing section configured to generate expectation data which indicates the sequence number of the packet which should be transferred next to the subsequent block, as the expectation; and a read control section configured to read a group of storage packets stored in the packet storage section, to transfer to the subsequent block. The write control section compares the extraction sequence number and the expectation, stores the reception packet in the packet storage section when the extraction sequence number is larger than the expectation.

### CROSS-REFERENCE TO RELATED APPLICATION

This is a continuation of International Application No. PCT/JP2011/051435, filed on Jan. 26, 2011.

### TECHNICAL FIELD

The present invention relates to a packet aligning apparatus and a packet alignment method.

### BACKGROUND ARTS

In a packet communication system, a transmitting unit and a receiving unit are connected to each other via a network. The transmitting unit transmits a group of packets in a predetermined order and the receiving unit receives the group of packets. There is a case that the transmitted packet is discarded because of a bit error in the network, and congestion of a unit in the network. Thus, in order to improve reliability of communication, a protocol having a packet re-transmission control function (ex. Transmission Control Protocol (TCP)) has been employed. According to such a protocol, a re-transmission time-out period is set. When the transmitting unit transmits a packet and arrival of the packet is not confirmed even if the re-transmission time-out period elapses, the transmitting unit re-transmits the packet not yet arrived.

In the network such as a data center, Round Trip Time (RTT) is short. Accordingly, in terms of RTT, the re-transmission time-out period can be set short. If the re-transmission time-out period can be set to have a small value, communication efficiency can be improved. However, the protocol is implemented in software. For example, TCP is implemented in software in an operating system such as Linux. The processing speed of the software is limited. For this reason, the re-transmission time-out period cannot be set short because of the processing speed of the software even if the re-transmission time-out period can be set short in terms of RTT. In case of using TCP, it is believed that, generally, the re-transmission time-out period cannot be set to 10 m/s or smaller.

As a related technique, a technique of performing re-transmission control in a lower layer at high speed is described in Non-Patent Literature 1. According to the re-transmission control technique described in Non-Patent Literature 1, time-out determination is made in a Media Access Control (MAC) layer in units of microseconds. Compared to the time-out period of TCP, re-transmission control operating at higher speed can be realized. Thus, in case of using the network having a short RTT, such as the data center, communication efficiency can be improved.

### CITATION LIST

[Non-Patent Literature 1]: Tohru Takamichi, Masahiro Shigihara, Kiyoshi Hukuchi, “Consideration of Ultrahigh Speed MAC Method for Terabit-Class LAN”, the Communications Society Conference of The Institute of Electronics, Information and Communication Engineers, 2008

### SUMMARY OF THE INVENTION

When a transmitting unit re-transmits a packet, a group of packets may arrive at a receiving unit in the order that is different from original order. When the arriving order of the packets is changed, the receiving unit must align the group of packets. As described above, an aligning process of a protocol having the packet re-transmission control function, such as TCP, is executed in software. However, the packet aligning process in software often requires complicated memory management for aligning packets. Consequently, the aligning process largely consumes CPU resources. It is disadvantageous that this increases a processing load in the receiving unit.

A packet aligning apparatus according to the present invention includes a packet analyzing section for receiving a packet containing a sequence number indicating transmission order as a received packet and extracting the sequence number contained in the received packet as an extracted sequence number, a packet storing section configured to read data in a read order, a write control section for deciding whether to store the received packet in the packet storing section or to transfer the received packet to a subsequent block based on the extracted sequence number, an expectation managing section for generating expectation data indicating the sequence number of a packet to be transferred next to the subsequent block as an expectation, a maximum sequence number managing section for generating maximum sequence number data indicating a maximum value of the sequence number of the group of stored packets stored in the packet storing section as a maximum sequence number, and a read control section for reading the group of stored packets from the packet storing section and transferring the packets to the subsequent block. The write control section compares the extracted sequence number with the expectation, and compares the extracted sequence number with the maximum sequence number when the extracted sequence number is larger than the expectation, stores the received packet in the packet storing section when the extracted sequence number is larger than the maximum sequence number, and transfers the received packet to the subsequent block when the extracted sequence number is equal to the expectation. When the extracted sequence number is equal to the expectation, the read control section transfers the group of stored packets to the subsequent block after transfer of the received packet to the subsequent block.

A packet alignment method according to the present invention includes receiving a packet containing a sequence number indicating transmission order as a received packet and extracting the sequence number contained in the received packet as an extracted sequence number, deciding whether to store the received packet in a packet storing section configured to read data in the read order or to transfer the received packet to a subsequent block based on the extracted sequence number, generating expectation data indicating the sequence number of a packet to be transferred next to the subsequent block as an expectation, generating maximum sequence number data indicating the sequence number of a maximum packet having the largest sequence number among the group of stored packets stored in the packet storing section as a maximum sequence number, and reading the group of stored packets from the packet storing section and transferring the packets to the subsequent block. The deciding includes comparing the extracted sequence number with the expectation, and comparing the extracted sequence number with the maximum sequence number when the extracted sequence number is larger than the expectation, storing the received packet in the packet storing section when the extracted sequence number is larger than the maximum sequence number and transferring the received packet to the subsequent block when the extracted sequence number is equal to the expectation. The transferring to the subsequent block includes transferring the group of stored packets to the subsequent block after transfer of the received packet to the subsequent block when the extracted sequence number is equal to the expectation.

A storage medium according to the present invention stores a packet alignment program therein. The packet alignment program is a computer program for implementing the packet alignment method by use of a computer.

According to the present invention, it is possible to provide the packet aligning apparatus, the packet alignment method, and the storage medium that can prevent an increase in a processing load in the receiving unit.

### BRIEF DESCRIPTION OF THE DRAWINGS

The above-mentioned and other objects, advantages, and features will become more apparent from exemplary embodiments of the present invention, which will be described in conjunction with following figures.

FIG. 1 is a block diagram showing a packet aligning apparatus according to a first exemplary embodiment of the present invention;

FIG. 2 is a diagram showing a format of each stored packet contained in a group of packets;

FIG. 3 is a flow chart showing an operating method of the packet aligning apparatus;

FIG. 4 is a diagram showing an operation the packet aligning apparatus;

FIG. 5 is a block diagram showing the packet aligning apparatus according to a second exemplary embodiment;

FIG. 6A is a flow chart showing an operating method of the packet aligning apparatus according to the second exemplary embodiment;

FIG. 6B is a flow chart showing the operating method of the packet aligning apparatus according to the second exemplary embodiment;

FIG. 7 is a diagram showing effects of the packet aligning apparatus according to the second exemplary embodiment; and

FIG. 8 is a schematic view showing a configuration of a packet storing section according to a third exemplary embodiment.

### DESCRIPTION OF EXEMPLARY EMBODIMENTS

Hereinafter, a packet aligning apparatus of the present invention will be described in detail with reference to the attached drawings.

### First Exemplary Embodiment

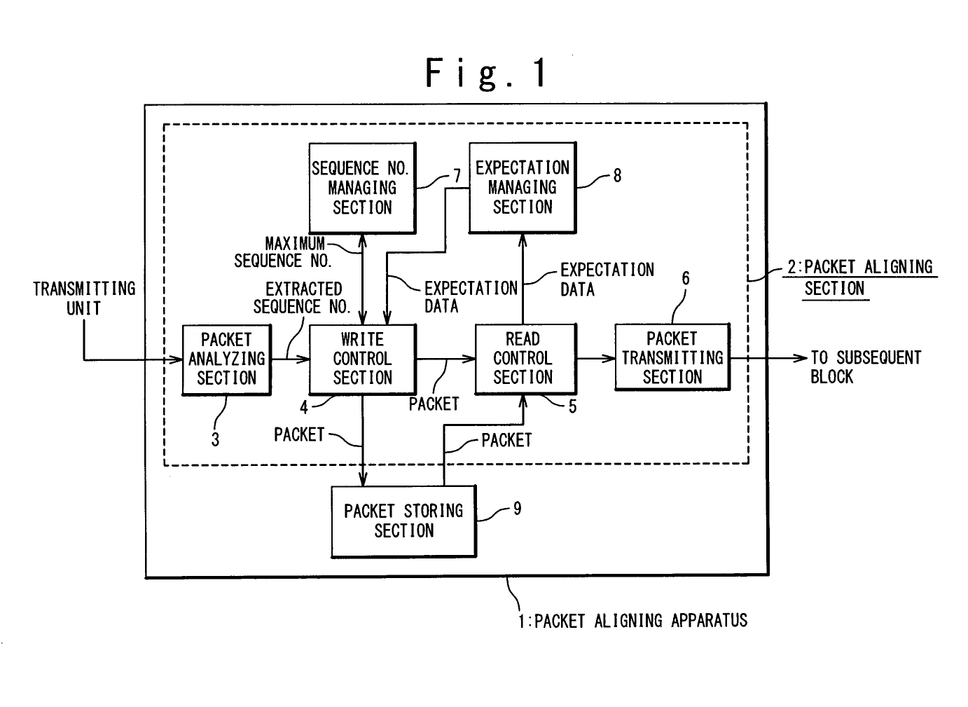

FIG. 1 is a block diagram showing a configuration of a packet aligning apparatus 1 according to the present exemplary embodiment of the present invention. The packet aligning apparatus 1 is provided on the side of a packet receiving unit. The packet aligning apparatus 1 aligns a plurality of packets transmitted from a transmitting unit in order and transmits the aligned packets, to a subsequent block which functions as an upper layer block (for example, a TCP block).

Here, it is assumed that the transmitting unit is configured to transmit the plurality of packets in an order in units of groups of packets. Also, it is assumed that the transmitting unit is configured to assign a sequence number indicating a transmission order to each of the plurality of packets. Furthermore, it is assumed that the transmitting unit is configured to re-transmit the packet not yet arrived when the packet not yet arrived at the subsequent block exists among the plurality of packets. For example, the transmitting unit can determine whether or not an acknowledgement (data indicating that the packet has been received) is sent from the subsequent block within a preset re-transmission time-out period, thereby recognizing whether or not the transmission packet arrives.

As shown in FIG. 1, the packet aligning apparatus 1 is provided with a packet aligning section 2 and a packet storing section 9. The packet aligning section 2 is provided with a packet analyzing section 3, a write control section 4, a read control section 5, a packet transmitting section 6, a sequence number managing section 7 and an expectation managing section 8. Among these sections, the packet aligning section 2 may be implemented as an integrated circuit, or implemented through execution of a packet alignment program stored in a Read Only Memory (ROM) by use of a CPU. The packet alignment program is previously installed into the ROM from a storage medium such as a CD-ROM or a DVD-ROM. The packet storing section 9 is configured to read written data in the order they were written.

First, a general operation of the packet aligning apparatus 1 will be described. The packet aligning apparatus 1 manages the sequence number of the packet to be transmitted next to a subsequent block as an expectation. When a packet is discarded before arrival at the packet aligning apparatus 1, the transmitting unit re-transmits the discarded packet. Here, there might be a case that the transmitting unit transmits a packet next to the discarded packet before re-transmission of the discarded packet. In this case, the packet aligning apparatus 1 receives the packet having the sequence number that is larger than the expectation. At this time, the packet aligning apparatus 1 stores the received packet in the packet storing section 9. After that, the packet aligning apparatus 1 receives the re-transmission packet. At that time, the packet aligning apparatus 1 receives the packet having the sequence number equal to the expectation. The packet aligning apparatus 1 transmits the received packet to the subsequent block as it is. That is, the re-transmission packet is transmitted to the subsequent block as it is. Further, after transmitting the re-transmission packet, the packet aligning apparatus 1 reads the packet stored in the packet storing section 9 and transmits the read packet to the subsequent block. When a plurality of packets have been stored in the packet storing section 9, they are transmitted to the subsequent block in the order they were written into the packet storing section 9.

Through the above-mentioned operation, even if the arrival order of each of groups of packets at the packet aligning apparatus 1 is replaced by another, the group of packets is transferred to the subsequent block in a correct order. Accordingly, even if the transmitting unit re-transmits a packet, there is no need to rearrange the order of the group of packets in the subsequent block. Thus, the packet aligning apparatus 1 only need to determine whether each of the packets stored is stored in the packet storing section 9 or is transmitted to the subsequent block in software as it is. The packet aligning apparatus 1 does not need to rearrange the order of the group of packets stored in a buffer in software. Therefore, it becomes possible to reduce a processing load for rearranging the order of the packets.

Next, a configuration of the packet aligning apparatus 1 will be described in detail.

The packet storing section 9 temporarily stores the group of packets. The group of packets stored in the packet storing section 9 is hereinafter referred to as a group of storage packets. The packet storing section 9 is configured from a First-In-First-Out (FIFO) unit to read and write data. That is, the group of storage packets is read in the order they were written.

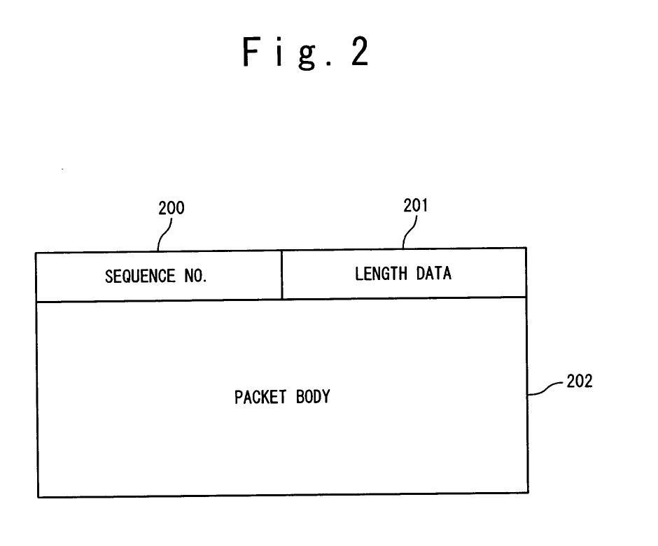

FIG. 2 is a diagram showing a format of each storage packet contained in the group of storage packets. As shown in FIG. 2, the format of each storage packet includes a packet body 202, a sequence number 200, and length data 201. The length data 201 indicates a data amount of the packet body 202. The sequence number 200 and the length data 201 are provided at the top portion of the packet.

When receiving the packet from the transmitting unit as a reception packet, the packet analyzing section 3 analyzes the reception packet (reception packet). Specifically, the packet analyzing section 3 analyzes header information of the reception packet and extracts the sequence number.

The expectation managing section 8 generates expectation data. The expectation data indicates the sequence number of a packet to be transferred next to the subsequent block as an expectation. The expectation is updated by the read control section 5. The sequence number of a firstly transmitted packet among the plurality of packets is set as an initial value of the expectation. The initial value is previously informed, for example, from the transmitting unit to the packet aligning apparatus 1.

The sequence number managing section 7 generates maximum sequence number data indicating a maximum sequence number. The maximum sequence number is equal to a maximum value of the sequence numbers of the group of storage packets stored in the packet storing section 9. In accordance with data transmitted from the write control section 4, the sequence number managing section 7 generates the maximum sequence number data. In an initial state, the maximum sequence number is set to the value that is smaller than a minimum value of a possible sequence number. In the present exemplary embodiment, in the initial state, the maximum sequence number is set to 0.

The write control section 4 determines whether the reception packet is stored in the packet storing section 9 or is transferred to the subsequent block. The write control section 4 receives the reception packet and the extracted sequence number from the packet analyzing section 3. Then, the write control section 4 determines whether the reception packet is in the transmission order (in-order) or not (out-of-order). Specifically, the write control section 4 acquires the expectation data from the expectation managing section 8, determines whether the reception packet is in the in-order or the out-of-order and compares the expectation with the extracted sequence number. When the extracted sequence number is larger than the expectation, the write control section 4 acquires the maximum sequence number data. Then, the write control section 4 compares the expectation with the maximum sequence number and determines whether or not the reception packet is stored in the packet storing section 9 on the basis of the comparison result.

The read control section 5 transfers the packet to the subsequent block. When the reception packet is transferred to the subsequent block, the write control section 4 passes the reception packet to the read control section 5. The read control section 5 transmits the reception packet to the packet transmitting section 6 so as to transfer the packet to the subsequent block through the packet transmitting section 6. Also, the read control section 5 has a function of accessing to the packet storing section 9 and transmitting the group of storage packets to the subsequent block through the packet transmitting section 6.

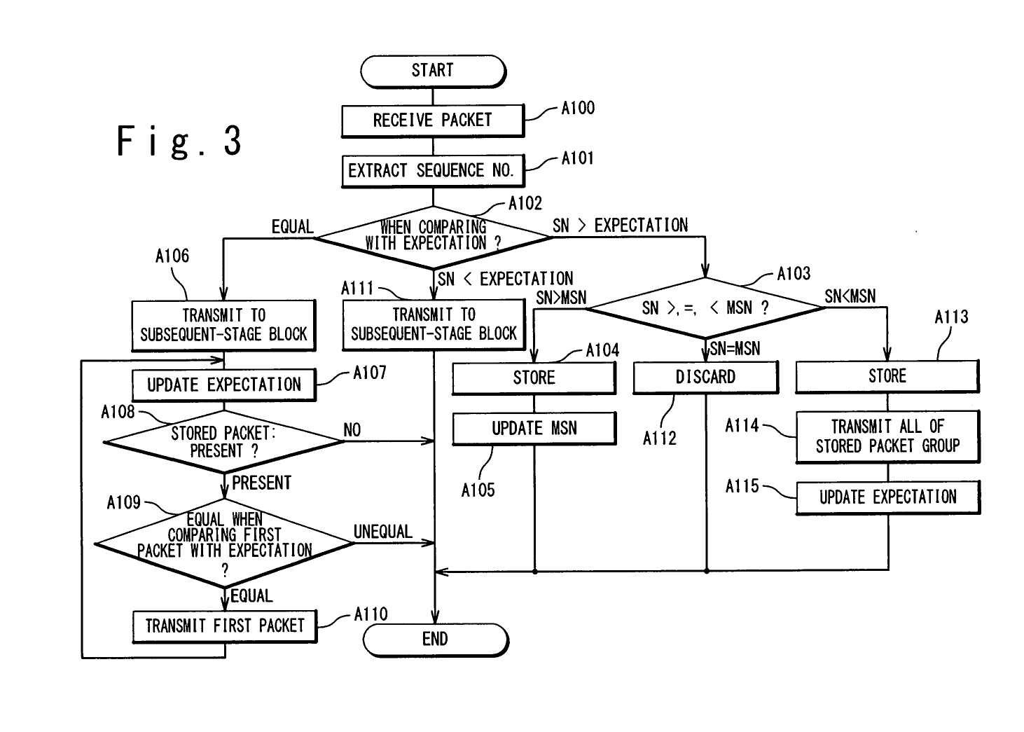

Subsequently, an operating method of the above-mentioned packet aligning apparatus 1 will be described. FIG. 3 is a flow chart showing an operating method of the packet aligning apparatus 1.

Step A100:

It is assumed that the packet analyzing section 3 receives a packet from the transmitting unit.

Step A101:

The packet analyzing section 3 extracts the sequence number from a packet header of the reception packet as the extracted sequence number SN. The packet analyzing section 3 transmits the extracted sequence number SN and the reception packet to the write control section 4.

Step A102:

The write control section 4 acquires the expectation data from the expectation managing section 8. Then, the write control section 4 compares the extracted sequence number SN with the expectation. When the extracted sequence number SN is larger than the expectation, the process at Step A103 is executed. When the extracted sequence number SN is equal to the expectation, the process at Step A106 is executed. When the extracted sequence number SN is smaller than the expectation, the process at Step A111 is executed.

Step A103:

When the extracted sequence number SN is larger than the expectation, the write control section 4 acquires the maximum sequence number data from the sequence number managing section 7. Then, the write control section 4 compares the extracted sequence number SN with the maximum sequence number MSN.

Step A104:

When the extracted sequence number SN is larger than the maximum sequence number MSN, the write control section 4 stores the reception packet as the storage packet in the packet storing section 9.

Step A105:

Next, the write control section 4 informs to the sequence number managing section 7 that the maximum sequence number MSN is to be updated. The sequence number managing section 7 updates the maximum sequence number data so as to indicate the sequence number of the packet stored at Step A104 as the maximum sequence number.

Step A106:

At Step A102, when the extracted sequence number is equal to the expectation, the write control section 4 transfers the reception packet to the subsequent block as it is. That is, the write control section 4 passes the reception packet to the read control section 5. The read control section 5 passes the reception packet to the packet transmitting section 6. The packet transmitting section 6 transmits the reception packet to the subsequent block.

Step A107:

After the reception packet is transmitted to the subsequent block, the read control section 5 issues an instruction for update of the expectation to the expectation managing section 8. When receiving the update instruction, the expectation managing section 8 increments the expectation indicated by the expectation data. That is, the expectation is updated to the sequence number of a packet to be transmitted next to the subsequent block.

Step A108:

After the update of the expectation, the read control section 5 accesses to the packet storing section 9 and confirms whether or not the storage packet exists in the packet storing section 9. The packet storing section 9 is configured to output an empty signal when the storage packet does not exist. The read control section 5 can confirm existence or absence of the storage packet by reading the empty signal. When the storage packet exists, the process at Step S109 is executed. When the storage packet does not exist, the control operation is ended.

Step A109:

When the storage packet exists, the read control section 5 reads the sequence number of a first packet (packet stored first) among a group of storage packets. Then, the read control section 5 determines whether or not the sequence number of the first packet is equal to the expectation. As a result of determination, when they are equal to each other, the process at Step A110 is executed. As a result of determination, when they are not equal to each other, the control operation is ended. The method of reading the sequence number of the first packet is not specifically limited. For example, the sequence number of the first packet can be read previously by using an FIFO memory as the packet storing section 9.

Step A110:

When the sequence number of the first packet is equal to the expectation, the read control section 5 reads the first packet and transmits the first packet to the subsequent block through the packet transmitting section 6. At this time, referring to the length data 201 of the first packet, the read control section 5 reads only the first packet from the packet storing section 9. After that, the process at Step A107 and the subsequent steps is repeated.

Step A111:

At Step A102, when the extracted sequence number SN is smaller than the expectation, the write control section 4 passes the reception packet to the read control section 5. The read control section 5 passes the reception packet to the packet transmitting section 6 and the packet transmitting section 6 transmits the reception packet to the subsequent block. That is, the reception packet is transmitted to the subsequent block as it is.

Step A112:

At Step A103, when the extracted sequence number SN is equal to the maximum sequence number MSN, the reception packet is regarded as a packet previously stored as the storage packet. Accordingly, the write control section 4 discards the reception packet and the control operation ends.

Steps A113 to A115:

At Step A103, when the extracted sequence number SN is smaller than the maximum sequence number MSN, the group of packets cannot be aligned. Thus, the process at the following Steps A113 to A115 is executed and then the control operation is ended. That is, the write control section 4 temporarily stores the reception packet in the packet storing section 9 (Step A113). After that, the read control section 5 reads all of storage packets of a group stored in the packet storing section 9 and transmits the packets to the subsequent block (Step A114). After that, the expectation managing section 8 updates the expectation to a value obtained by adding “1” to the maximum sequence number MSN (Step A115). The group of packets transmitted to the subsequent block without being aligned is aligned in the subsequent block.

According to the above-mentioned operating method, even if the group of packets does not arrive in an expected order, the group of packets is transmitted to the subsequent block in the expected order. With reference to a specific example, this will be described below in detail.

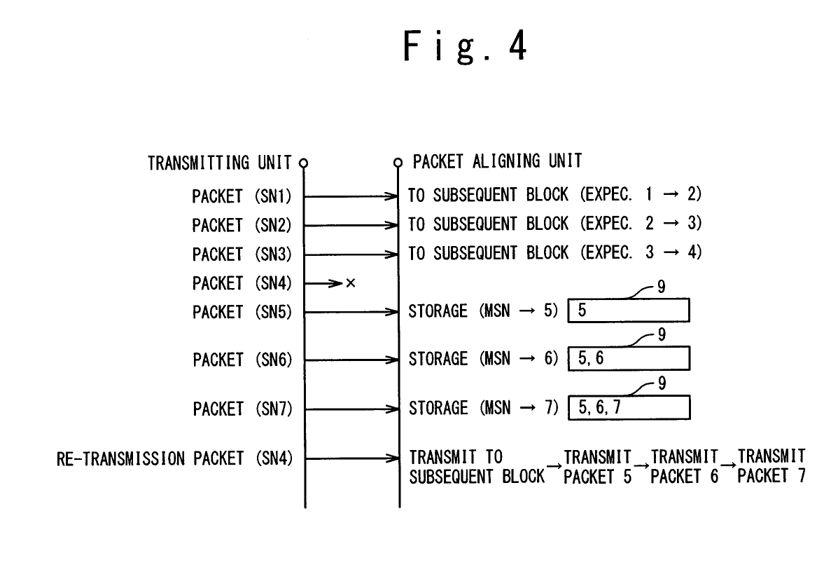

FIG. 4 is a diagram showing an operation of the packet aligning apparatus 1. As shown in FIG. 4, it is assumed that the transmitting unit transmits packets (SN1) to (SN7) to the packet aligning apparatus 1. A numeral following SN represents the sequence number. For example, the packet (SN1) has the sequence number of “1” and is transmitted first. Here, the following situation is assumed. That is, the packets (SN1) to (SN3) arrive at the packet aligning apparatus 1 as expected. However, the packet (SN4) is discarded on the way and does not arrive at the packet aligning apparatus 1. Further, the transmitting unit transmits the packets (SN5) to (SN7) in this order. After transmission of the packet (SN7), the packet (SN4) is re-transmitted as a re-transmission packet (SN4). In this case, the packet aligning apparatus 1 receives the group of packets in the order of the packet (SN1), the packet (SN2), the packet (SN3), the packet (SN5), the packet (SN6), the packet (SN7) and the re-transmission packet (SN4).

The operation of the alignment apparatus 1 at reception of each packet will be described below.

At Step A102, it is determined that the extracted sequence number (=1) is equal to the expectation (initial value=1), when the packet aligning apparatus 1 receives the packet (SN1). Accordingly, at Step A106, the packet (SN1) is transmitted to the subsequent block. Then, at Step A107, the expectation is updated from “1” to “2”.

Also, at reception of the packet (SN2), the packet aligning apparatus 1 transmits the packet (SN2) to the subsequent block as it is. The expectation is updated from “2” to “3”.

Also, at reception of the packet (SN3), the packet aligning apparatus 1 transmits the packet (SN3) to the subsequent block as it is. The expectation is updated from “3” to “4”.

At reception of the packet (SN5), at Step A102, it is determined that the extracted sequence number (=5) is larger than the expectation (=4). Accordingly, at Step A103, the extracted sequence number (=5) is compared with the maximum sequence number (=0). The extracted sequence number SN (=5) is larger than the maximum sequence number (=0). Accordingly, at Step A104, the packet (SN5) is stored in the packet storing section 9. At Step A105, the maximum sequence number is updated from “0” to “5”.

Also, at reception of the packet (SN6), the extracted sequence number (=6) is larger than the expectation (=4). Accordingly, the write control section 4 compares the extracted sequence number SN (=6) with the maximum sequence number (=5). Since the extracted sequence number (=6) is larger than the maximum sequence number (=5), the write control section 4 stores the packet (SN6) in the packet storing section 9. The maximum sequence number is updated from “5” to “6”.

Also, at reception of the packet (SN7), the extracted sequence number (=7) is larger than the expectation (=4). Accordingly, the write control section 4 compares the extracted sequence number SN (=7) with the maximum sequence number (=6). Since the extracted sequence number (=7) is larger than the maximum sequence number (=6), the write control section 4 stores the packet (SN7) in the packet storing section 9. The maximum sequence number is updated from “6” to “7”.

At reception of the re-transmission packet (SN4), at Step A102, it is determined that the extracted sequence number (=4) is equal to the expectation (=4). Accordingly, at Step A106, the re-transmission packet (SN4) is transmitted to the subsequent block as it is. After that, through the process at Steps A107 to A110, the group of storage packets is transmitted to the subsequent block. The group of storage packets is transmitted to the subsequent block in the order they were written. That is, the group of storage packets is transmitted to the subsequent block in the order of the packet SN5, the packet SN6, and the packet SN7.

As apparent from the above-mentioned description, the packets (SN1) to (SN7) are transmitted to the subsequent block in the correct order.

As described above, in the present exemplary embodiment, even if the order of arrival of the group of packets is changed, the group of packets can be passed to the subsequent block in the correct order. For this reason, there is no need to perform the aligning process of the group of packets in the subsequent block, thus reducing the load necessary for the aligning process in the subsequent block.

In addition, the packet aligning apparatus 1 may determine whether the reception packet is stored in the packet storing section 9 or is transmitted to the subsequent block as it is. There is no need to rearrange the order of the group of packets stored in a buffer (memory) or the like, thereby eliminating a need to perform complicated memory management process. As a result, the processing load for rearranging the order of the packets can be reduced.

### Second Exemplary Embodiment

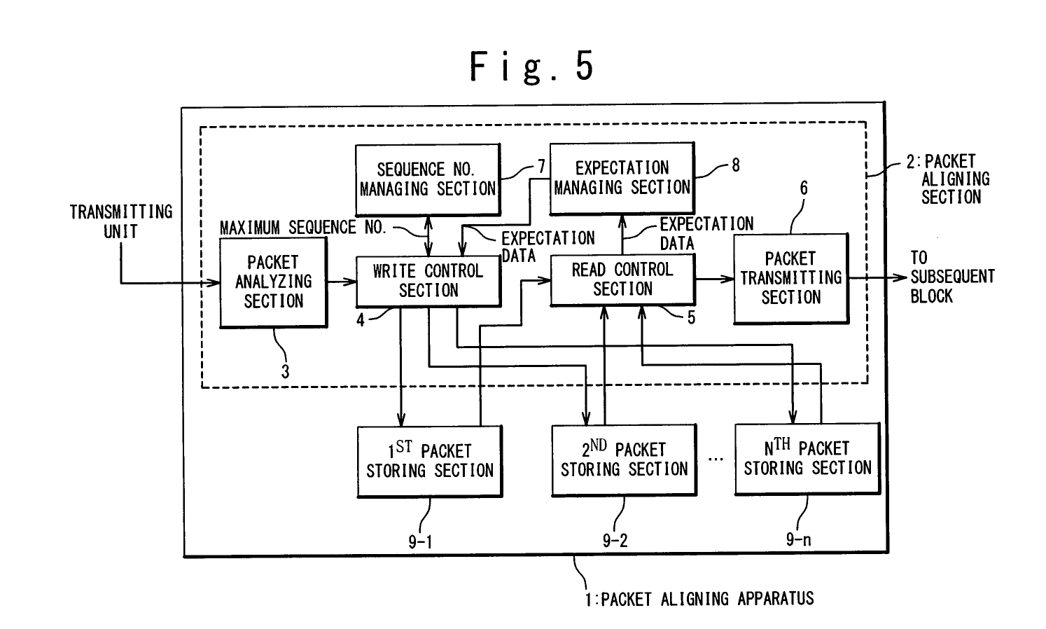

Subsequently, a second exemplary embodiment will be described. FIG. 5 is a block diagram showing a packet aligning apparatus 1 in accordance with the present exemplary embodiment. As shown in FIG. 5, in the present exemplary embodiment, a plurality of packet storing sections 9 are provided. That is, the packet aligning apparatus 1 includes a first packet storing section 9-1, a second packet storing section 9-2, . . . and an n^{th} packet storing section 9-n. In the present exemplary embodiment, the sequence number managing section 7 manages the maximum sequence number for each of the plurality of packets storing sections 9. Other configuration is the same as that in the first exemplary embodiment and thus, the detailed description thereof is omitted.

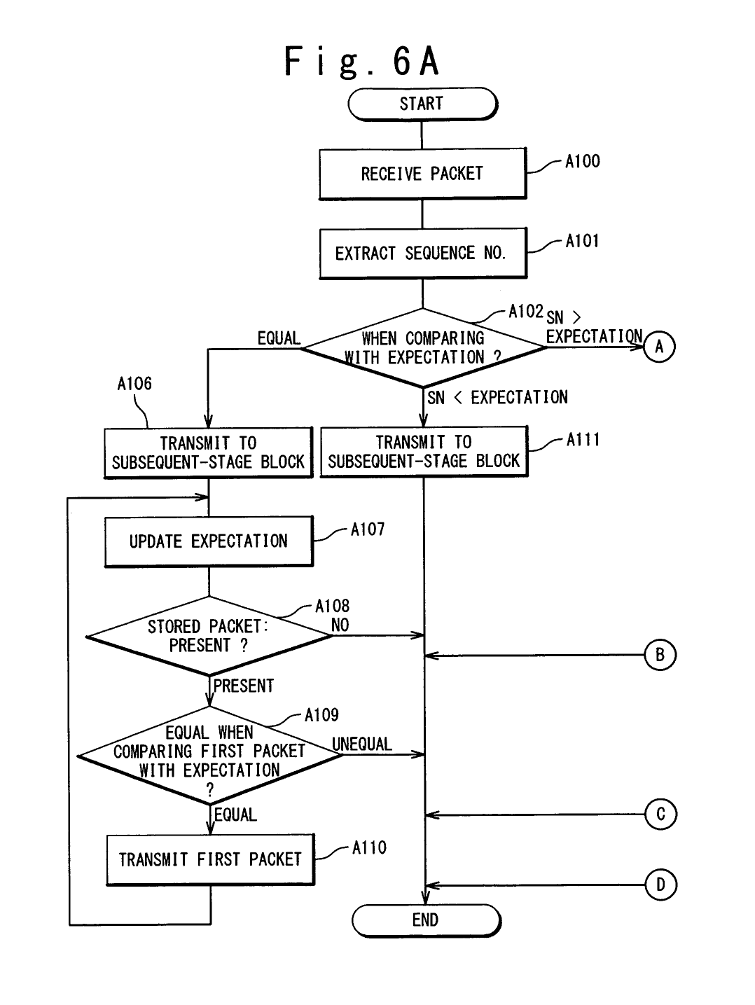

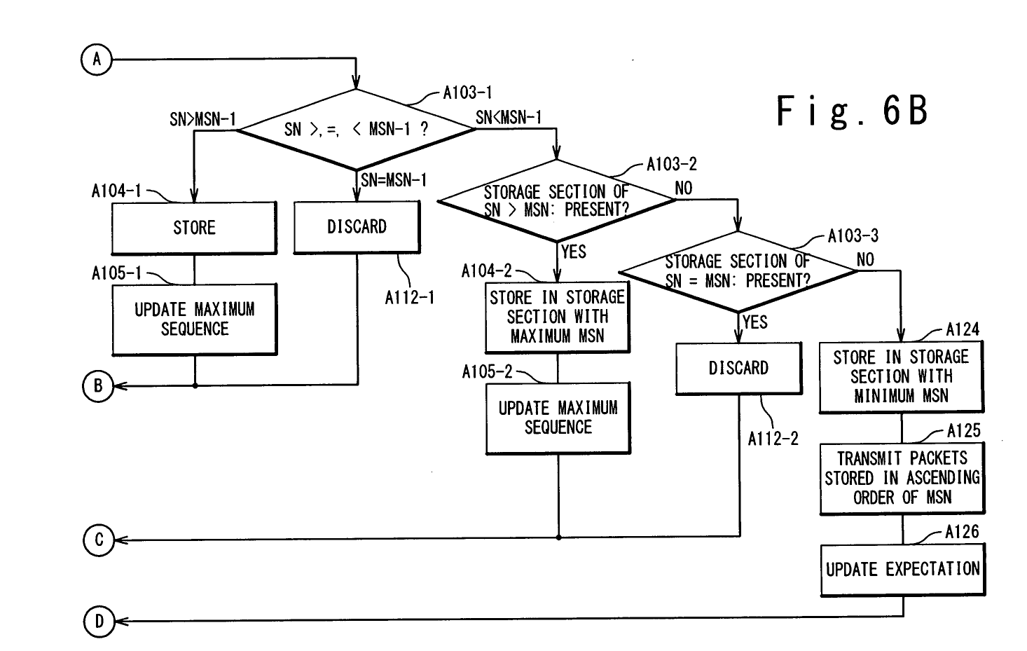

An operating method of the packet aligning apparatus 1 according to the present exemplary embodiment of the present invention will be described. FIGS. 6A and 6B are a flow chart showing the operating method of the packet aligning apparatus 1 in the present exemplary embodiment.

Steps A100 to A102:

As in the first exemplary embodiment, when receiving a packet (Step A100), the packet analyzing section 3 extracts the sequence number SN of the reception packet (Step A101). Then, the write control section 4 compares the extracted sequence number SN with the expectation (Step A102).

When the extracted sequence number SN is larger than the expectation, the process at Step A103-1 and the subsequent steps is executed. When the extracted sequence number SN is equal to the expectation, the process at Step A106 and the subsequent steps is executed. When the extracted sequence number SN is smaller than the expectation, the process at Step A111 is executed and as in the first exemplary embodiment, the reception packet is transmitted to the subsequent block.

Step A103-1:

When the extracted sequence number SN is larger than the expectation, the write control section 4 acquires the maximum sequence number data. Then, the write control section 4 compares the extracted sequence number SN with the maximum sequence number MSN-1 of the first packet storing section 9-1.

Step A104-1:

When the extracted sequence number SN is larger than the maximum sequence number MSN-1, the write control section 4 stores the reception packet in the first packet storing section 9-1.

Step A105-1:

Then, the write control section 4 accesses to the sequence number managing section 7 and updates the value of the maximum sequence number MSN-1 corresponding to the first packet storing section 9-1 to a value of the extracted sequence number SN.

Step A103-2:

At Step A103-1, when the extracted sequence number SN is smaller than the maximum sequence number MSN-1, the write control section 4 compares the extracted sequence number SN with the maximum sequence numbers MSN of other packet storing sections 9. Then, the write control section 4 determines whether or not the packet storing section 9-i (2≦i≦5 n) having the maximum sequence number MSN that is smaller than the extracted sequence number SN exists in the plurality of packets storage parts 9.

Step A104-2:

When the packet storing section 9-i exists, the write control section 4 stores the reception packet in the maximum sequence number 9-i. When there is a plurality of packet storing sections 9 having the maximum sequence number MSN that is smaller than the extracted sequence number SN, the write control section 4 selects the packet storing section having the largest maximum sequence number from the plural packet storing sections 9 as the packet storing section 9-i and stores the reception packet in the selected packet storing section 9-i.

Step A105-2:

After that, the write control section 4 accesses to the sequence number managing section 7 and updates the maximum sequence number corresponding to the packet storing section 9 in which the reception packet is stored at Step A104-2, to the value of the extracted sequence number SN.

Step A106:

At Step A102, when the extracted sequence number SN is equal to the expectation, the write control section 4 transmits the reception packet to the subsequent block through the read control section and the packet transmitting section 6.

Step A107:

After that, the expectation is updated to a next value. That is, the read control section 5 issues an update instruction to the expectation managing section 8 and the expectation managing section 8 updates the expectation.

Step A108:

After that, the read control section 5 accesses to the plurality of packet storing sections 9 and confirms whether or not the stored packet exists in the plurality of packet storing sections 9. When no storage packet exists, the control operation is ended. When no storage packet exists, the process in next Step A109 is executed.

Step A109:

After that, the read control section 5 reads the sequence number of the first packet (packet stored first) in each packet storing section 9 and compares the read sequence number with the expectation. Then, the read control section 5 determines whether or not there exists the packet storing section 9 in which the first packet having the sequence number equal to the expectation is stored. When the packet storing section 9 does not exist, the control operation is ended. When the packet storing section 9 having the first packet corresponding to the expectation exists, the process in next Step A110 is executed.

Step A110:

Next, the read control section 5 reads the first packet having the sequence number corresponding to the expectation. Then, the read control section 5 transmits the read first packet to the subsequent block. After that, the process at Step A107 and the subsequent steps is repeated.

Step A103-3:

At Step A103-2, when there exists no packet storing section 9 that satisfies “the extracted sequence number SN> the maximum sequence number MSN”, the write control section 4 confirms whether or not there exists the packet storing section 9 having the maximum sequence number MSN matching the extracted sequence number MSN.

Steps A124 to A126:

At Step A103-3, when there exists no packet storing section 9 that satisfies that the maximum sequence number MSN is equal to the extracted sequence number SN, the extracted sequence number SN is smaller than all of the maximum sequence number of the plurality of packet storing sections 9. In this case, the group of packets cannot be transmitted to the subsequent block in a desired order. Accordingly, the write control section 4 temporarily stores the reception packet in the packet storing section 9 having the smallest maximum sequence number among the plurality of packet storing sections 9 (Step A124). After that, the read control section 5 selects the packet storing section 9 in which the first packet having the smallest sequence number is stored, from the plurality of packet storing sections 9. Then, the read control section 5 reads the first packet in the selected packet storing section 9 and transmits the first packet to the subsequent block. The read control section 5 repeats this process until all of the packet storing sections 9 become empty (Step A125). After that, the expectation managing section 8 updates the expectation to a next value (a value obtained by adding “1” to a maximum value among MSN-1 to MSN-n) (Step A126).

### Steps A112-1, A112-2: Discard

At Step A103-1, when the extracted sequence number SN is equal to the maximum sequence number MSN-1, the same packet as the reception packet is previously stored in the first packet storing section 9-1. Accordingly, the write control section 4 discards the reception packet (Step A112-1). Similarly, at Step A103-3, when there exists the packet storing section 9 having the maximum sequence number MSN equal to the extracted sequence number SN, the same packet as the reception packet has been previously stored. Accordingly, the write control section 4 discards the reception packet (Step A112-2).

In the above-mentioned configuration and operation, even if the order of arrival of a plurality of re-transmission packets may be changed, the group of packets can be transmitted to the subsequent block in a desired order. Using a specific example, this will be described below. It is assumed that the plurality of packet storing sections 9 are the first packet storing section 9-1 and the second packet storing section 9-2.

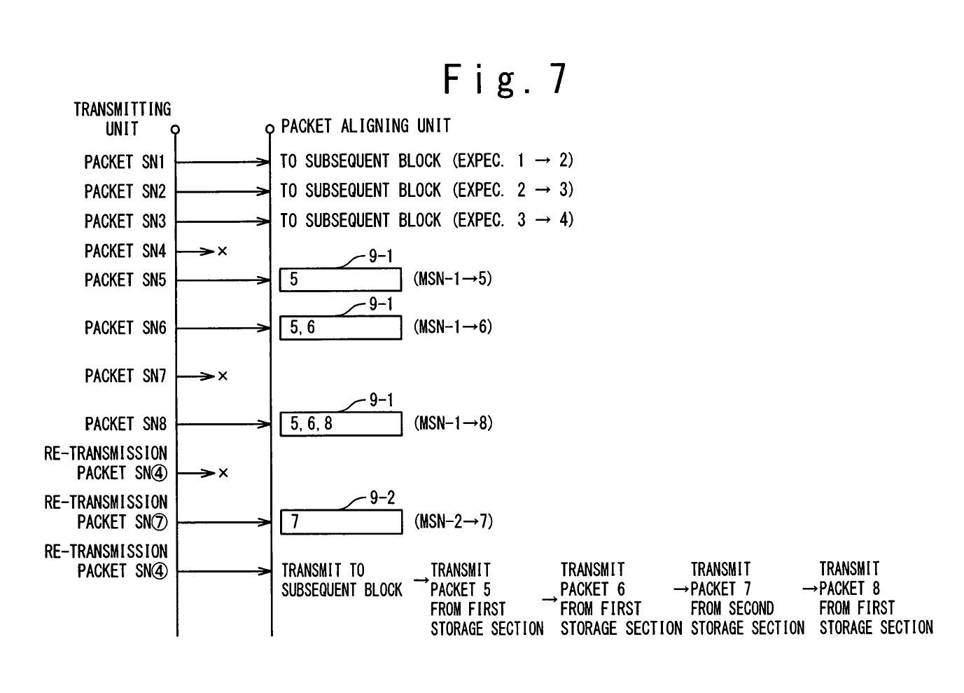

FIG. 7 is a diagram showing an operation of the packet aligning apparatus 1 according to the present exemplary embodiment. As shown in FIG. 7, it is assumed as follows. The transmitting unit transmits the packets (SN1) to (SN8). A numeral following SN represents the sequence number. Here, the packets (SN1) to (SN3) arrive at the packet aligning apparatus 1 in a correct order. The packet (SN4) does not arrive at the packet aligning apparatus 1. After that, the packets (SN5) and (SN6) arrive at the packet aligning apparatus 1. Further, the packet (SN7) does not arrive. After that, the packet (SN8) arrives at the packet aligning apparatus 1. Here, after transmission of the packet (SN8), the transmitting unit transmits the re-transmission packet (SN4), but the re-transmission packet (SN4) does not arrive at the packet aligning apparatus 1. Further, after that, the transmitting unit transmits the re-transmission packet (SN7) and the re-transmission packet (SN7) arrives at the packet aligning apparatus 1. After that, the transmitting unit transmits the re-transmission packet (SN4) and the packet aligning apparatus 1 receives the re-transmission packet (SN4). That is, the packet aligning apparatus 1 receives the group of packets in the order of the packet (SN1), the packet (SN2), the packet (SN3), the packet (SN 5), the packet (SN6), the packet (SN7), the re-transmission packet (SN7) and the re-transmission packet (SN4). The operation of the packet aligning apparatus 1 at reception of each packet will be described below.

When the packet aligning apparatus 1 receives the packet (SN1), it is determined at Step A102 that the extracted sequence number (=1) is equal to the expectation (initial value=1). Accordingly, at Step A106, the packet (SN1) is transmitted to the subsequent block. Then, at Step A107, the expectation is updated from “1” to “2”.

Also, when the packet aligning apparatus 1 receives the packet (SN2), as at reception of the packet (SN1), the packet (SN2) is transmitted to the subsequent block and the expectation is updated from “2” to “3”.

Also, at reception of the packet (SN3), similarly, the packet (SN3) is transmitted to the subsequent block and the expectation is updated from “3” to “4”.

At reception of the packet (SN5), it is determined at Step A102 that the extracted sequence number SN (=5) is larger than the expectation (=4). Accordingly, at Step A103-1, the maximum sequence number MSN-1 (=0) is compared with the extracted sequence number SN (=5) and it is determined that the extracted sequence number SN is larger than the maximum sequence number MSN-1. Accordingly, at Step A104-1, the reception packet (SN5) is stored in the first packet storing section 9-1. At Step A105-1, the maximum sequence number MSN-1 is updated to “5”.

Also, at reception of the packet (SN6), the same process as that at the reception of the packet (SN5) is executed. That is, the reception packet (SN6) is stored in the first packet storing section 9-1. The maximum sequence number MSN-1 is updated from “5” to “6”.

Also, at reception of the packet (SN8), the same process as that at the reception of the packet (SN5) is executed. That is, the reception packet (SN8) is stored in the first packet storing section 9-1. The group of storage packets is stored in the order of the packet (SN5), the packet (SN6), and the packet (SN8) in the first packet storing section 9-1 from its head. The maximum sequence number MSN-1 is updated from “6” to “8”.

At reception of the re-transmission packet (SN7), it is determined at Step A102 that the extracted sequence number SN (=7) is larger than the expectation (=4). At Step A103-1, it is determined that the extracted sequence number (=7) is smaller than the maximum sequence number MSN-1 (=8). At Step A103-2, it is determined whether or not there exists the packet storing section 9 that satisfies SN>MSN. Here, in the second packet storing section 9-2, no stored packet exists and the maximum sequence number MSN-2 is “0”. That is, the second packet storing section 9-2 is a packet storing section that satisfies SN>MSN. Accordingly, at Step A104-2, the reception packet (SN7) is stored in the second packet storing section 9-2. The maximum sequence number MSN-2 is updated from “0” to “7”.

At reception of the re-transmission packet (SN4), it is determined at Step A102 that the extracted sequence number SN (=4) is equal to the expectation (=4). Accordingly, at Step A106, the re-transmission packet (SN4) is transmitted to the subsequent block as it is. After that, at Step A107, the expectation is updated from “4” to “5”. Then, at Step A108, it is determined whether or not the storage packet exists, and since the storage packet exists, the process at Step A109 is executed. At Step A109, the sequence number of the first packet is compared with the expectation (=5). Here, in the first packet storing section 9-1, the sequence number of the first packet is “5” and thus, is equal to the expectation. Accordingly, at Step A110, the packet (SN5) is read from the first packet storing section 9-1 and transmitted to the subsequent block. Subsequently, the process at Step A107 and the subsequent steps is repeated. In this manner, the group of packets is transmitted to the subsequent block in the order of the packet (SN6), the packet (SN7) and the packet (SN8).

As described above, in the present exemplary embodiment, even if the order of arrival of the plurality of re-transmission packets may be changed, the group of packets can be transmitted to the subsequent block in a desired order.

### Third Exemplary Embodiment

Subsequently, a third exemplary embodiment will be described. As compared to the above-mentioned exemplary embodiments, in the present exemplary embodiment, a configuration of the packet storing section 9 is changed. Other configuration is the same as those in the above-mentioned exemplary embodiments and thus, detailed description thereof is omitted.

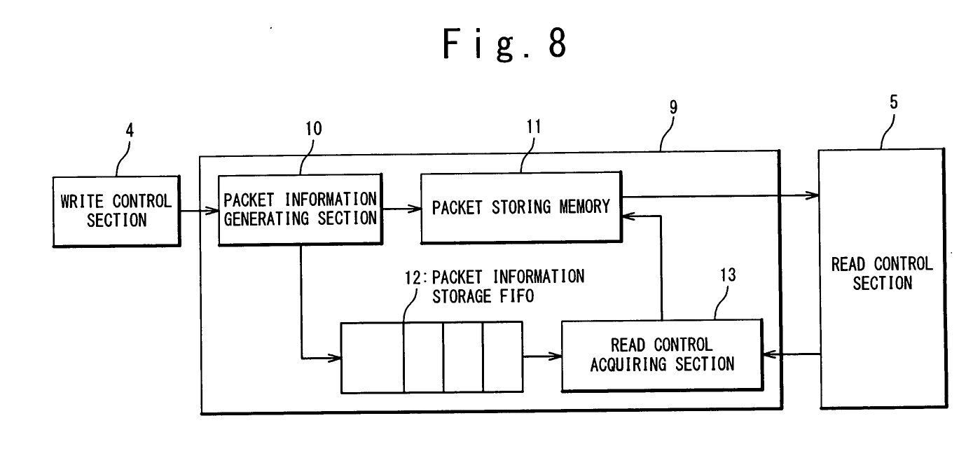

FIG. 8 is a schematic view showing the configuration of the packet storing section 9 in the present exemplary embodiment. As shown in FIG. 8, the packet storing section 9 includes a packet information generating section 10, a packet storing memory 11, a packet information storage FIFO 12, and a read control acquiring section 13. The packet information generating section 10 and the read control acquiring section 13 may be implemented by executing a packet alignment program stored in the storage medium by means of a CPU, or may be implemented in hardware by using an integrated circuit.

Upon occurrence of a packet write request, the packet information generating section 10 acquires a packet to be stored and generates packet information. The packet information contains the sequence number of the packet to be stored, and a write start address and a write end address in the packet storing memory 11. The packet information generating section 10 writes the packet into the packet storing memory 11 and stores the packet information in the packet information storage FIFO 12. The packet information storage FIFO 12 is configured to read data in the order they were written.

Meanwhile, when reading the stored packet, the read control acquiring section 13 reads the packet information from the packet information storage FIFO 12. Then, the read control acquiring section 13 determines the start address and the end address of the packet to be read. The read control acquiring section 13 passes the determination result to the read control section 5. Based on the start address and the end address as the determination result, the read control section 5 reads the packet to be read from the packet storing memory 11.

The packet storing section 9 can read the group of packets in the order they were written by employing the configuration in the present exemplary embodiment. Moreover, in the present exemplary embodiment, since the packet storing section 9 is managed based on the start address and the end address of the packet, even if an error occurs in the access process to the packet storing section 9, the packet aligning process can be continued without exerting an influence on other packets.

The first to third exemplary embodiments of the present invention have been described. These exemplary embodiments are not independent from each other and may be combined with each other with no inconsistency.

The application claims priority based on Japanese Patent Application No. 2010-036002, filed on Feb. 22, 2010, the disclosure thereof is incorporated herein by reference.

What is claimed is:

1. A packet aligning apparatus comprising:
a packet analyzing section configured to receive a packet containing a sequence number which shows a transmission order, as a reception packet, and extract said sequence number contained in said reception packet as an extraction sequence number;
a packet storage section;
a write control section configured to determine whether or not a said reception packet is stored in said packet storage section based on said extraction sequence number or transferred to a subsequent block;
an expectation managing section configured to generate expectation data which indicates the sequence number of the packet which should be transferred next to said subsequent block, as the expectation;
s read control section configured to read a group of storage packets stored in said packet storage section, to transfer to said subsequent block,
wherein said write control section:
compares said extraction sequence number and said expectation, and
stores said reception packet in said packet storage section when said extraction sequence number is larger than said expectation,
transfers said reception packet to said subsequent block when said extraction sequence number is equal to said expectation, and
said read control section sends out the group of storage packets to said subsequent block after said reception packet is sent out to said subsequent block, when said extraction sequence number is equal to said expectation.

2. The packet aligning apparatus according to claim 1, wherein said packet storage section is configured to output packets in order in which the packets are written.

3. The packet aligning apparatus according to claim 2, further comprising:
a sequence number managing section configured to generate a maximum sequence number data which indicates a maximum of said sequence numbers in the group of storage packets, as a maximum sequence number,
wherein when said extraction sequence number is larger than said expectation, said write control section compares said extraction sequence number with said maximum sequence number, and when said extraction sequence number is larger than said maximum sequence number, said write control section stores said reception packet in said packet storage section.

4. The packet aligning apparatus according to claim 3, wherein a plurality of said packet storage sections are provided,
wherein said maximum sequence number managing section generates data which shows said maximum sequence number to each of said plurality of packet storage sections as said maximum sequence number data, and
wherein when said extraction sequence number is larger than said expectation, said write control section compares said maximum sequence number corresponding to each of said plurality of packet storage sections with said extraction sequence number, and determines whether or not said reception packet is transferred to said subsequent block based on the comparison result or is stored in said plurality of packet storage sections.

5. The packet aligning apparatus according to claim 4, wherein when said extraction sequence number is larger than said maximum sequence number corresponding to any of said plurality of packet storage sections, said write control section stores said reception packet in said packet storage section of said plurality of packet storage sections which has the largest of said maximum sequence numbers.

6. The packet aligning apparatus according to claim 1, wherein said packet storing section comprises:
a packet storing memory;
a packet information generation section; and
a packet information storage buffer configured in the FIFO (First-IN-First-OUT) form; and
a read information acquiring section,
wherein in a write, said packet information generation section stores a storage object packet in said packet storing memory, generates packet information which shows said sequence number contained in said storage object packet and write addresses of said storage object packet in said packet storing memory, and stores said packet information in said packet information storage buffer, and
wherein in a read, said reading information acquiring section reads said packet information from said packet information storage buffer based on said packet information, and reads a read object packet from said packet storing memory.

7. A packet aligning method comprising:
receiving a packet containing a sequence number which shows a transmission order, as a reception packet;
extracting said sequence number contained in said reception packet as an extraction sequence number;
determining whether or not said reception packet is stored in a packet storage section based on said extraction sequence number or is transferred to a subsequent block;
generating expectation data which shows said sequence number of the packet which should be sent out next to said subsequent block as an expectation; and
reading and sending out a group of storage packets stored in said packet storage section to said subsequent block,
wherein said determining comprises:
comparing said extraction sequence number and said expectation;
storing said reception packet in said packet storage section when said extraction sequence number is larger than said expectation, and
transferring said reception packet to said subsequent block when said extraction sequence number is equal to said expectation,
wherein said sending out comprises:
sending out the group of storage packets to said subsequent block, after said reception packet is sent out to said subsequent block, when said extraction sequence number is equal to said expectation.

8. A computer-readable non-transitory recording medium which stores a computer-executable program code for attaining a packet aligning method which comprising:
receiving a packet containing a sequence number which shows a transmission order, as a reception packet;
extracting said sequence number contained in said reception packet as an extraction sequence number;
determining whether or not said reception packet is stored in a packet storage section based on said extraction sequence number or is transferred to a subsequent block;
generating expectation data which shows said sequence number of the packet which should be sent out next to said subsequent block as an expectation; and
reading and sending out a group of storage packets stored in said packet storage section to said subsequent block,
wherein said determining comprises:
comparing said extraction sequence number and said expectation;
storing said reception packet in said packet storage section when said extraction sequence number is larger than said expectation, and
transferring said reception packet to said subsequent block when said extraction sequence number is equal to said expectation,
wherein said sending out comprises:
sending out the group of storage packets to said subsequent block, after said reception packet is sent out to said subsequent block, when said extraction sequence number is equal to said expectation.
